(19) United States
(12) Patent Application Publication
(10) Pub. No.: US 2008/0059564 A1
(43) Pub. Date: Mar. 6, 2008

(54) System and Method for Electronically Receiving, Filtering and Selling Content on a Website

(76) Inventor: Jennifer D. Persson, Saratoga, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/468,687

(22) Filed: Aug. 30, 2006

(51) Int. Cl. G07G 1/14; G06F 15/16

(52) U.S. Cl. 709/203; 709/219; 705/14

(57) ABSTRACT

A system and method for enabling content providers to upload content and if there is validation of the quality of or demand for the content based upon feedback provided by visitors to a website then such highly ranked content is made available for sale to visitors of the website. The present invention provides an easy technique for many content providers to expose their content widely while providing potential buyers of the content a reasonable choice of desirable content to purchase since, in one embodiment, only highly ranked content is made available for sale.

### FIELD OF THE INVENTION

This invention relates generally to internet commerce and more particularly to a website that permits uploading, filtering and selling of content.

### BACKGROUND OF THE INVENTION

Electronic commerce websites are prevalent on the Internet. Many, such as Amazon.com, sell products and provide the opportunity for visitors to provide feedback on the products.

Separate from electronic commerce websites are websites such as Youtube.com that permit a visitor to upload content, e.g., a video, which can be viewed by any visitor to the website. Visitors can also rate the content. Such websites have a model based upon making money by advertising on their websites. Other conventional websites enable the uploading, displaying and selling of content but do not limit sales based upon filtering/ranking of content.

A problem with the electronic commerce industry is that it is difficult for an unsophisticated seller of a quality product/content to get his or her product/content onto electronic commerce websites without getting buried by lower quality content.

### SUMMARY OF THE INVENTION

The present invention provides a system and method that enables a user to electronically upload content onto a website, allows visitors to provide feedback about the content, based upon this feedback (at least as one factor) the content is ranked, and content that is ranked high enough is made available for sale on the website (or on another website). A benefit of the invention is that a user with a quality product/content can upload their content and if validated by the visitors to the website (by receiving complementary feedback) the user may be able to have the content be made available for sale.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is an illustration of a network environment in which one embodiment of the present invention may operate.

FIG. 2 is a flowchart illustrating the operation of one embodiment of the present invention.

### DETAILED DESCRIPTION OF THE INVENTION

A preferred embodiment of the present invention is now described with reference to the figures where like reference numbers indicate identical or functionally similar elements. Also in the figures, the left most digit of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

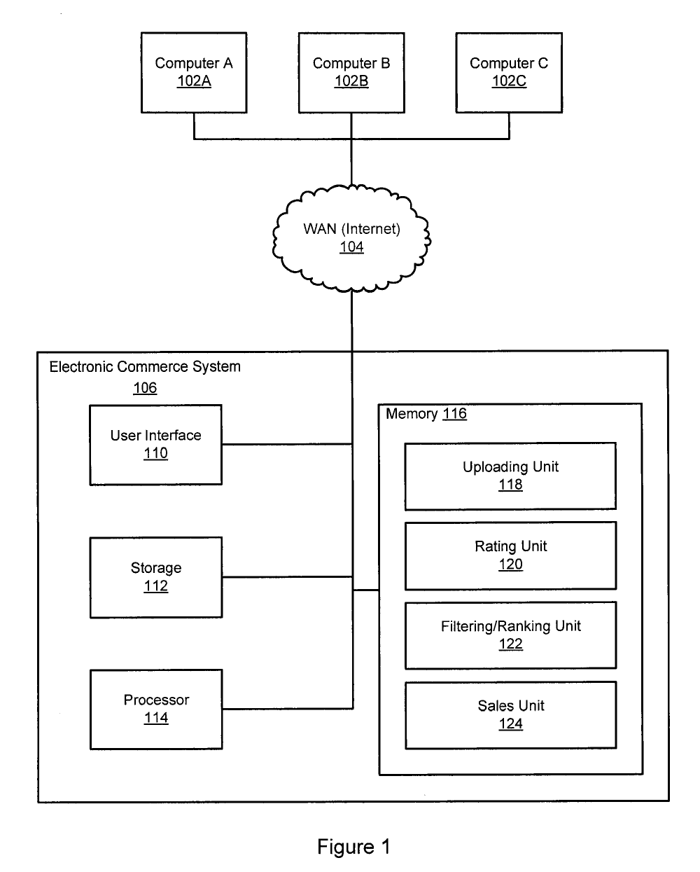

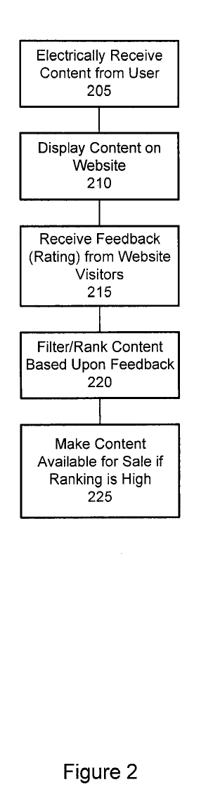

FIG. 1 is an illustration of a network environment in which one embodiment of the present invention may operate. Devices 102A, 102B, 102C are any device that can connect to a wide area network (WAN) 104 such as the Internet. These devices 102 can be computer, personal device assistants, phones, etc and can connect to the WAN 104 wirelessly or by a wireline connection. For ease of reference such devices 102 will be referred to herein as computers. An electronic commerce system 106 is connected to the WAN 104 and is available to the users of the computers 102. The electronic commerce system 106 includes a user interface 110, such as a website, a storage module 112, a processor 114 and a memory unit 116. The memory unit includes an uploading unit 118, a rating unit 120, a filtering/ranking unit 122 and a sales unit 124. In some embodiments of the present invention one or more of the components (110, 112, 114, 116, 118, 120, 122, 124) can be positioned in close proximity to each other while in other embodiments these components can be positioned in geographically distant locations. For example the units in memory 116 can be programs capable of being executed by one or more processors that are located in separate computing devices. The operation of the electronic commerce system is described in greater detail below with reference to FIG. 2.

FIG. 2 is a flowchart illustrating the operation of one embodiment of the present invention. The uploading unit 118 utilizes the user interface 110 and electronically receives 205 content from a user. There are a variety of conventional ways this can be accomplished including having a user utilize a computer 102 to upload content onto a server or storage device 112 controlled by the electronic commerce system 106. Example of such content include video, audio, pictures, ringtones, wallpapers, music, alerts, voicemail greetings, animations, video ringtones, drawings/cartoons, ringback tones, similar types of entertainment content, etc.

After receiving the content the electronic commerce system 106 displays 210 the content on the website 110 while preventing the content from being downloaded in a user-usable form to prior to receiving authorization from the electronic commerce system 106. In one embodiment, the content is reviewed manually, automatically, or using a combination of both, based upon various criteria, e.g., legality, e.g., copyright compliance, profanity, obscenity, adult material, hateful material, FCC-compliance, formatting requirements, etc., prior to displaying 210 the content on the website. In alternate embodiments, some or all of this review takes place prior to making the content available for sale 225 and in some embodiments some or all of the review occurs only if the content is highly ranked (as determined by the filtering/ranking unit 122). After displaying 210 the content, visitors/users to the website have the ability to access the content and provide feedback about the content which is received 215 by the rating unit 120. In some embodiments, the visitors/users will be required to be members of the electronic commerce system 106 or similarly log into the system in order to provide feedback on content.

The filtering/ranking unit 122 utilizes the user feedback in order to filter/rank 220 the received content. The ranking can be separated by media type (video, ringtone, wallpaper, genre, artist, date, etc., so to have different rankings for various types and sub-types of content. For example, the ranking unit 122 can have a ranking of all videos uploaded or can have a sub-type of musical videos and generate a ranking based upon on musical videos. It is envisioned that many different factors can be used to generate a ranking. In one embodiment, hits on a content link are not used as the sole basis for ranking although it may be used in alternate embodiments. In some embodiments the filter/ranking unit 122 uses other factors in conjunction with the rating provided by the user as filters to determine a ranking. Such other factors may include agreements with owners, aggregators and/or agents of the content, distributors of content or other business partnerships, subjective factors including the comments provided by visitors/users such as the level of detail set forth in the comments, previous comments on different content by a particular visitor/user, the level of passion in the comments, etc, can also be used to determine the ranking.

Content that is highly ranked, based upon the results of the filtering/ranking unit 122, are made available for sale on the website 110. It is envisioned that the website 110 can actually be multiple websites which may have a similar uniform resource locator (URL), although this is not required. In other embodiments, the website can be multiple websites such that the displaying and ranking/filtering can be done at one website and the selling of content can be done at a separate website that may or may not be controlled by a entity that is different from the entity/entities that controls the website that receives 205 the content, that receives feedback 215 or filters 220 the content. In some embodiments proceeds from the sale are shared between different parties including the content owner and the owners of the electronic commerce system 106. In another embodiment the content is sold via the sales unit 124 and the purchase price is billed to the purchaser via a third party, e.g., a telephone company, a credit card company, etc.

The present invention enables content providers, e.g., a college student, to upload content and if there is validation of the quality of and/or demand for the content based upon feedback provided by visitors to the website then such highly ranked content is made available for sale to visitors to the website. In contrast to conventional systems the present invention provides an easy technique for many content providers to expose their content widely while providing potential buyers a reasonable choice of desirable content to purchase since, in one embodiment, the present invention filters the content such that only highly ranked content is made available for sale.

In another embodiment the rankings can be used to separate the highly ranked content from the lower ranked content using two or more tiers. In one embodiment the content from all tiers is made available 225 for sale but a potential buyer can view the various tiers separately. For example, the website may have a category of “4-5 Star Ringtones” and another category of “3-4 Star Ringtones” where a star is a measure used in the user feedback or generated by the rating unit based upon user feedback. In one embodiment a potential buyer may select content in any of the categories and content from that category is displayed and made available 225 for sale. This enables the user to receive ranking information and to easily see the content in which he/she is most interested without cluttering up the display with content outside of the rankings that are of interest.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A method for performing electronic commerce comprising the steps of:
electronically receiving a first content from a user via a internet interface;
electronically displaying said first content on a website;
receiving feedback about said first content from visitors to said website;
filtering said first content using said feedback to generate a ranking of said content; and
offering to electronically sell said first content if said ranking is above a first threshold.

2. The method of claim 1, further comprising the step of:
authorizing a visitor to provide feedback, wherein only feedback that is received from visitors who have been authorized to provide feedback are used to rank said first content.

3. The method of claim 1, wherein said content is at least one of video, audio, pictures, ringtones, wallpapers, music, alerts, voicemail greetings, animations, video ringtones, drawings, cartoons, or ringback tones.

4. The method of claim 1, further comprising the step of:
electronically selling said first content.

5. The method of claim 4, wherein said user receives a portion of an amount paid for the content.

6. A system for performing electronic commerce comprising:
content receiving means for electronically receiving a first content from a user via a internet interface;
display means for electronically displaying said first content on a website;
feedback means for receiving feedback about said first content from visitors to said website;
filtering means for filtering said first content using said feedback and for generating a ranking of said content; and
selling means for offering to electronically sell said first content if said ranking is above a first threshold.

7. The system of claim 6, further comprising:
authorization means for authorizing a visitor to provide feedback, wherein only feedback that is received from visitors who have been authorized to provide feedback are used to rank said first content.

8. The system of claim 6, wherein said content is at least one of video, audio, pictures, ringtones, wallpapers, music, alerts, voicemail greetings, animations, video ringtones, drawings, cartoons, or ringback tones.

9. The system of claim 6, wherein said selling means includes a means for electronically selling said first content.

10. The system of claim 9, wherein said user receives a portion of an amount paid for the content.
